(19) United States
(12) Patent Application Publication
(10) Pub. No.: US 2024/0175830 A1
(43) Pub. Date: May 30, 2024

(54) MEASURING DEVICE WITH GAS-CONDUCTING ELEMENT AND METHOD FOR RINSING THE MEASURING DEVICE

(71) Applicant: Anton Paar GmbH, Graz (AT)

(72) Inventor: Bernhard Bauer, Lebring (AT)

(21) Appl. No.: 18/517,507

(22) Filed: Nov. 22, 2023

(30) Foreign Application Priority Data
Nov. 25, 2022 (AT) A50899/2022

(51) Int. Cl. G01N 25/48

(52) U.S. Cl. CPC G01N 25/4813

(57) ABSTRACT

A measuring device, in particular a calorimeter, is described which comprises:
i) a sensor device which is configured for capturing a measurand with respect to a sample and which comprises:
ia) a base region, and
ib) a sample storing region which protrudes from a main surface of the base region and which is configured for storing a sample reception;
ii) a sensor interior in which the sensor device is at least partially arranged;
iii) a rinsing gas supply device which is configured for providing a rinsing gas into the sensor interior; and
iv) a gas-conducting element which covers the sensor interior and which comprises: at least one opening through which the protruding sample storing region at least partially extends, such that a slit between a side wall of the protruding sample storing region and the gas-conducting element remains.

This application claims the benefit of the filing date of the Austrian Patent Application No. A50899/2022 filed 25 Nov. 2022, the disclosure of which is hereby incorporated herein by reference.

### TECHNICAL FIELD

The disclosure relates to a measuring device, in particular a measuring device for a thermal analysis, further in particular for a thermal differential measurement, which comprises a gas-conducting element. Moreover, the disclosure relates to a method for rinsing a measuring device which comprises the gas-conducting element. Furthermore, the disclosure relates to a use of a specific lid in an interior of a measuring device.

### TECHNOLOGICAL BACKGROUND

Measuring devices for a thermal analysis are principally known and encompass differential scanning calorimeters (DSC) and differential thermal analyses (DTA), for example. Generally, such a measuring device comprises an oven in which two sample containers are located, wherein a sample container is provided with a sample and the other one is provided with a reference (the reference may also simply be an empty sample container). This structure enables the measurement of different physical properties which are related to a change in temperature. For example, if phase transitions and/or phase conversions in the sample occur, (at the same supplied heat amount by the oven) a temperature difference between the sample container with the sample and the sample container with the reference is formed. The temperature difference and/or the heat flow between the sample and the reference is then measured by sensors, whereby conclusions to the type of the phase transition and/or the phase conversion are enabled.

It is generally known to rinse the oven interior with diverse gases (“rinsing gas”). On the one hand, the rinsing gas may be a gas which reacts with constituents of the sample to be analyzed, on the other hand it may also be an inert gas, i.e., a gas which does not react with the sample, to avoid reactions with air. Typical rinsing gases encompass dry air, oxygen, nitrogen, argon, helium, carbon monoxide, and carbon dioxide. For example, oxygen may be introduced, to activate oxidation effects during the calorimetrical measurement. Vice versa, when rinsing with an inert gas (e.g. argon, helium, or nitrogen), each oxidation can be suppressed.

The reliable and controlled rinsing of the oven chamber, in particular with respect to the samples, may therefore be very important in a thermal analysis. The composition, the volume flow, and the temperature of the gas or the gas mixture shall correspond to the desired value as exactly as possible. When using an inert gas, the rinsing of the sample chamber has to be sufficiently sized, such that no residual oxygen remains in the sample chamber, in particular not at the crucible with the sample. On the other hand, the rinsing gas participates in the heat transfer from the oven to the sample, mainly by convection. This may falsify the measuring result and/or has an undesired influence on the measuring result. Thus, the streaming velocity of the rinsing gas which reaches the crucibles should have a low streaming velocity and a deviation to the crucible temperature which is as low as possible.

In prior art, openings in the bottom and/or in the wall of the oven are provided for the rinsing gas supply, through which the respectively required gas can be supplied. The rinsing gas is connected to the rinsing gas inlet opening at the device via a pressure regulator and a stream measurement device. An outlet for the rinsing gas is in turn provided in the top of the measuring device above the oven chamber.

However, such constructions may comprise distinct disadvantages. For example, in case of an inlet in the bottom and an outlet in the top, distinct rinsing losses and inhomogeneous streaming conditions may occur. A (main) part of the rinsing gas may exit through the outlet opening directly from the inlet in an unused manner, without being distributed in the sample chamber. By the different inhomogeneous streaming conditions at different locations of the oven chamber, measurement errors may additionally occur.

### SUMMARY OF THE DISCLOSURE

There may be a need to rinse a measuring device efficiently and reliably, in particular for a thermal analysis.

A measuring device, a method, and a use are described in the following.

According to a first aspect of the disclosure, a measuring device, in particular a calorimeter, further in particular a differential calorimeter, is described, which comprises:
i) a sensor device (in particular a temperature sensor device) which is configured for capturing a measurand (in particular the temperature) with respect to a sample (in particular in a sample reception, such as a crucible), and which comprises:
ia) a base region (e.g. a support structure), and
ib) a sample storing region (in particular comprising a platform for arranging a sample crucible) which protrudes from a main surface (in particular which extends in the horizontal along x, y) of the base region (in particular in the vertical along z), and which is configured for storing (e.g. on the platform) a sample reception;
ii) a (fluid-filled, in particular gas/air-filled) sensor (interior) chamber (or oven chamber) in which the sensor device is at least partially arranged;
iii) a rinsing gas supply device (e.g. a supply conduit) which is configured for providing (streaming) a rinsing gas into the sensor interior; and
iv) a gas-conducting element (for example a covering sheet metal) which covers (or closes) the sensor interior and which comprises: at least one opening through which the protruding sample storing region at least partially extends, such that a slit between a side wall of (an upper region of) the protruding sample storing region and the gas-conducting element remains (through which the rinsing gas can stream from the sensor interior in a sample interior which is arranged above it).

According to a second aspect of the disclosure, a method for rinsing a measuring device (in particular as described above) is claimed, the method comprising:
i) providing a rinsing gas in a sensor interior in which at least partially a sensor device is arranged, wherein the sensor device comprises a base region from which a sample storing region protrudes; and
ii) covering the sensor interior by a gas-conducting element, such that the protruding sample storing region at least partially extends through an opening of the gas-conducting element, so that a slit between a side wall of the protruding sample storing region and the gas-conducting element remains;
   in particular iii) streaming the rinsing gas from the sensor interior through the slit into an (adjacent) sample interior.

According to a third aspect of the disclosure, a use of a gas-conducting element (lid) with at least one opening is described, for covering a sensor interior of a measuring device with respect to a sample interior, such that a substantially homogenous rinsing gas flow through the sensor interior into the (in particular to a sample reception in the) sample interior is provided.

In the context of this document, the term “gas-conducting element” may in particular denote each objective device which is suitable for influencing the flow of a gas, such that the gas stream and/or the gas flow is guided in a certain direction and/or in a certain manner. In a preferred embodiment, the gas-conducting element comprises an opening which influences the streaming direction of a gas. Further preferred, the opening is put (German: gestülpt) over the upper part of a sample receiving region of the measuring device, such that however at least one slit between the gas-conducting element and the sensor device remains. The opening may be round, cornered, or otherwise shaped, wherein it may be advantageous when the geometry of the opening is adapted to the geometry of the sample receiving region. In particular, the desired gas-conducting effect may be caused by the slit, whereby, instead of an inhomogeneous gas flow into the sample interior, a homogenously distributed, in particular homogenous, gas flow may be provided. Preferably, the gas-conducting element comprises a material which is heat-resistant in the oven interior, e.g., a metal, such as silver. Furthermore, the gas-conducting element may be configured as a lid which separates a sensor interior from the sample interior. The slit (in particular ring slit) made of the openings in the gas-conducting element and the outer surfaces of the sample storing region may act as a “nozzle” for the gas flow.

In the context of this document, the term “sensor device” may in particular denote a device which is configured for capturing a measurand with respect to a sample. In the case of a thermal analysis, the sensor device may comprise a sample storing region, for example, on which a sample reception (with the sample) can be arranged. In an example, a contact structure (platform) which is provided for this purpose may be coupled to a measuring system, such as a thermal element wire. Furthermore, the sample storing region may be arranged on a stabilizing base region. While the base region provides a stabilizing supporting function, the sample storing region may serve for arranging a sample (reception). The sensor device may be inserted in an oven interior (in particular sensor interior), such that, in case of a thermal analysis, heating is enabled. In an example, the sensor device is therefore assembled from heat-resistant materials.

Therefore, the term “oven interior” may relate to a region of the measuring device, which can be heated by a heating device. Finally, a sample in a sample reception shall be heated in the sample interior of the oven interior. In an example, also the sensor interior of the oven interior and the sensor device are heated.

In the context of this document, the term “gas supply device” may in particular denote a device which is suitable for enabling a supply of gas into an oven interior. In a simple example, the gas supply device comprises a gas supply conduit by which a rinsing gas from a reservoir can be transported to the oven interior to be rinsed. Such a gas supply conduit may e.g. comprise a tube and/or a capillary, and may conduct the gas from a gas reservoir which is arranged low (with respect to a measuring device in an operation position) upwards to the oven interior. In a more complex example, the gas may be (additionally) guided through a gas supply opening through the base region. In an example, between the gas-conducting element and the base region, a streaming channel may be formed. In an example, the gas-conducting element is not a part of the gas supply device. While the latter provides the gas into the sensor interior, the first can guide the gas flow from the sensor interior to the sample interior.

In this document, the term “measuring device” may in particular denote a device which is configured for measuring physical properties of a sample. Preferably, the physical properties are thermal properties and/or properties which are/become observable during a change of the ambient temperature. Examples for such properties may encompass: melting temperatures and glass transition temperatures (in particular for plastics), kinetic observations of chemical reactions, specific heat capacities, determination of the purity of substances (due to the change of the melting point which occurs by a contamination).

In this document, the term “sample reception” may denote each device at or in a measuring device which is suitable for receiving a sample to be measured. In particular, a sample reception may comprise at least one sample container (e.g. a crucible), in which the sample is provided for the measurement. When the measuring device shall perform a differential measurement, e.g., two sample containers are provided, one for the sample and a further one for the reference (it may also be empty). Moreover, the sample reception may comprise known sensorics for capturing e.g., changes of the temperature in/at the sample containers during a measurement. Recorded data may be forwarded to a control unit and/or an evaluation unit.

According to an exemplary embodiment, the disclosure may be based on the idea that a measuring device, in particular for a thermal analysis, can be rinsed in an especially efficient and reliable manner, when a gas-conducting element is provided, such that a homogeneous rinsing gas flow through the measuring device is enabled.

The rinsing of measuring devices, in particular oven interiors in case of a thermal analysis, by gas is known, wherein however conventionally an uncontrolled and inhomogeneous gas flow is present. In this connection, no efficient rinsing is achieved and unnecessarily much gas must be used, to compensate the inhomogeneous distribution.

Now, it was surprisingly recognized, that this technical problem is soluble in a simple but highly efficient manner, when the gas-conducting element between the sensor interior and the sample interior of the measuring device is provided, such that a sample storing region of a sensor device extends through an opening of the gas-conducting element. When a slit between the sample storing region and the gas-conducting element is left, a uniform and even homogenous (preferably rotational symmetrical) rinsing gas flow into the sample interior and along sample(s) (receptions) may result. In other words, the opening of the gas-conducting element may be sized such that between the sensor device and the gas-conducting element, a desired (homogeneous) stream may be established.

The described concept may be simply and directly implemented in existing systems. For example, a covering sheet metal made of a heat-resistant metal can be inserted in the oven interior. Since such an element can be simply exchanged, in case of a contamination, it can be rapidly cleaned or replaced. Therefore, the user saves elaborately (manually) cleaning of the oven (bottom). Moreover, the gas-conducting element may act as an additional protection for the sensor device and the oven bottom.

As simulations (see FIGS. 6 and 7) have shown, by this simple construction, a distinctly improved stream of the rinsing gas in the region of the outer surfaces of the sensor device can be achieved. Additionally, the improved stream of the rinsing gas leads to a more homogeneous tempering of the rinsing gas, whereby measurement errors due to a temperature inhomogeneity and temperature fluctuations are reduced.

The sensor device and the sample (receptions) are streamed in an efficient and uniform manner. Additionally, a more effective rinsing saves rinsing gas, whereby also an advantage with respect to costs and environment is present.

### EXEMPLARY EMBODIMENTS

According to an embodiment, the gas-conducting element is configured such that the rinsing gas is guided through the at least one opening (in particular exclusively through the one or more openings) out of the sensor interior. This may have the advantage that (substantially) the streaming direction of the entire rinsing gas becomes controllable. In this connection, it was shown that especially the remaining slit between the sensor device and the gas-conducting element can provide a surprisingly advantageous rinsing gas distribution. In an example, the gas-conducting element blocks the rinsing gas outside of the openings, such that it may enter from the sensor interior into the sample interior only via the opening(s).

According to a further embodiment, the gas-conducting element is formed (substantially) planar. In particular, the gas-conducting element can be formed as a lid (“covering sheet metal”) for the sensor interior. This may have the advantage that a gas-conducting element can be provided which is rapidly and cost-efficiently manufacturable. A (planar) lid shape, e.g., a metal surface, may be already sufficient to cover the sensor interior. An opening in the metal surface may be generated e.g., by stamping, etching, or cutting. Furthermore, the gas-conducting element may also be manufactured by e.g., injection molding or 3-D-print.

According to a further embodiment, the opening and the slit are comparable, in particular substantially the same, with respect to their area (German: flächigen) geometry. For example, the opening and the side wall of the sample storing region may comprise a round shape or a cornered shape. Also further geometrical shapes are possible.

According to a further embodiment, the distance between the side wall of the sample storing region and the gas-conducting element in the opening is in the range from 0.25 mm to 5 mm, in particular in the range from 0.5 mm to 2 mm. According to a further embodiment, the gas-conducting element comprises a thickness (z) in the range from 0.05 mm to 1 mm, in particular in the range from 0.1 mm to 0.5 mm.

These dimensions may provide an especially advantageous rinsing gas stream in an example in the case of an implementation in a measuring device for a thermal analysis. Furthermore, these dimensions may constitute an effective compromise between stability and material savings.

According to a further embodiment, the measuring device further comprises: a sample interior which is configured for containing at least one sample reception. The gas-conducting element may delimit the sensor interior from the sample interior. As already described above, by this delimitation, an especially advantageous gas stream from the sensor region to the sample (reception) region may be created. In particular, a homogeneous streaming around the sample receptions may be especially relevant in an example.

According to a further embodiment, the gas-conducting element comprises a heat-stable material, in particular a metal or a ceramic. In an example, the heat-stable material shall be stable up to a temperature of at least 600° C., in particular at least 750° C. E.g., silver or a (corrosion-resistant) metal alloy (e.g. a nickel base alloy) may be used as metal. In particular, a refractory ceramic (German: Feuerfestkeramik) may be used as ceramic, such as aluminum oxide.

According to a further embodiment, the gas-conducting element is removable and/or exchangeable in a destruction-free manner. This may have the advantage that the element can be cleaned and/or exchanged in a rapid, uncomplicated, and cost-efficient manner. For example, the gas-conducting element can be placed/fixed on a protrusion of the oven wall and may therefore be exchangeable in an especially simple manner.

According to a further embodiment, the sensor device further comprises:
i) a thin wall structure which contains the sample storing region, wherein the side wall delimits a hollow; and
ii) a contact structure (or a platform), which is in particular formed as a lid above the hollow, for contacting the sample reception.

Such a construction may be especially suitable for a thermal analysis.

Furthermore, such a construction may be effectively rinsed by the described method. In an example, the thin wall structure extends on the same height (z) as the contact structure or (slightly) below through the opening of the gas-conducting element.

According to a further embodiment, a width (e.g. 15 mm) of the base region is larger than a width of the sample storing region, in particular a width of the thin wall structure. The width may be determined along the x- or the y-axis. This may have the advantage that the base region may serve as a stable, massive support structure which may confer stability to the sample storing region. Furthermore, the base region may provide space for a reference sample storing region in an example.

According to a further embodiment, the base region further comprises: a gas flow opening which is configured for conducting the rinsing gas at least partially through the base region into the sensor interior, in particular wherein the base region comprises an upper element and a lower element, wherein the gas flow opening (as a discharge slit) is arranged between the upper element and the lower element. This configuration may enable an efficient stream into the sensor interior. In this connection, the base region may, besides a stabilizing function, also serve as a streaming channel. Furthermore, a passage may be used which may also be applied for a thermal element wire, for example.

According to a further embodiment, the sensor device further comprises: a reference sensor device which comprises a protruding reference sample storing region and which is arranged adjacent to the sample storing region. In particular, the reference sample storing region and the sample storing region are (substantially) structurally similar or identical. In this way, differential measurements for a thermal analysis may be performed.

According to a further embodiment, the gas-conducting element comprises at least one further opening through which the protruding reference sample storing region extends, such that a further slit between a further side wall of the protruding reference sample storing region and the gas-conducting element remains. This may have the advantage, that a reference sample reception is cleaned with the rinsing gas as efficiently and reliably as the sample reception. Gas streams through the opening and the further opening may be substantially identical.

According to a further embodiment, the measuring device comprises a differential sensing calorimeter or a differential thermal analysis measuring device. In this way, the described advantageous measuring device may be directly used for industry relevant measurements. DSC and DTA are principally known (see above), but may be performed in an especially efficient manner by the described measuring device.

According to a further embodiment, the measuring device comprises at least one of: a heating device, a cooling device, a thermal resistance, an electrothermal converter, in particular a Peltier-element, a rinsing gas supply conduit which extends at least partially through the measuring device. These elements may be advantageously implemented at least partially in a measuring device for a thermal analysis. A corresponding measuring device is described in detail in EP 3992621 A2, wherein this document is to be considered as incorporated by reference into the present document.

According to a further embodiment of the method, a flow of the rinsing gas exits out of the slit in a rotationally symmetrical manner, in particular substantially in a homogenously distributed manner. Particularly this rinsing gas stream may uniformly stream around and rinse the sample reception (and the sensor device) in an especially efficient manner.

According to a further embodiment, the method further comprises: providing a sample reception in a sample interior, in particular at the sample storing region, which is separated from the sensor interior by the gas-conducting element. In an example, rinsing the measuring device may be operated with or without sample reception(s). While the oven interior is cleaned in an example, in another example, additionally one or more sample receptions can be cleaned.

According to a further embodiment of the method, the flow of the rinsing gas through the sensor interior is tempering the rinsing gas. In particular, this may occur due to the fact that a heating device of the measuring device is heating the oven interior. The space between the oven bottom and the gas-conducting element may be used as a streaming channel with a heat exchanger function, in which the rinsing gas respectively streams away from the center towards the (e.g. ring-shaped) discharge openings around the sample storing region and is thereby tempered. Therefore, this streaming channel may be used as a heat exchanger for tempering the rinsing gas.

The above defined aspects and further aspects of the present disclosure result from the examples of the embodiments to be subsequently described and are explained with reference to the examples of the embodiments. In the following, embodiments of the invention are described in more detail with reference to embodiments, to which the disclosure is however not limited.

### BRIEF DESCRIPTION OF THE DRAWINGS

FIG. 1 shows a measuring device according to an exemplary embodiment of the invention.

FIG. 2 shows a measuring device with a reference sensor device according to an exemplary embodiment of the invention.

FIG. 3 shows a gas-conducting element according to an exemplary embodiment of the invention.

FIGS. 4 and 5 respectively show a sensor device and a reference sensor device according to exemplary embodiments of the invention.

FIGS. 6 and 7 respectively show simulations of the streaming gas through the gas-conducting element according to an exemplary embodiment of the invention.

FIG. 8 shows a measuring device with sample receptions according to exemplary embodiments of the invention.

### DETAILED DESCRIPTION OF THE DRAWINGS

The illustrations in the drawings are schematic. It is noted that in different figures, similar or identical elements or features are provided with the same reference signs or with reference signs which differ from the corresponding reference signs only in the first cipher. To avoid unnecessary repetitions, elements or features which have been already explained with reference to a previously described embodiment, are not explained again in a later passage of the description.

Moreover, spatially relative terms, such as “front” and “back”, “above” and “below”, “left” and “right” etc. are used to describe the relation of an element to another element, as illustrated in the figures. Thus, the spatially relative terms may apply to used orientations which deviate from the orientation which is illustrated in the figures. Obviously, these spatially relative terms only relate to a simplification of the description, and the orientation, which is shown in the figures, and are not necessarily limiting, since a device according to an embodiment of the invention may assume other orientations than those which are illustrated in the figures, in particular during use.

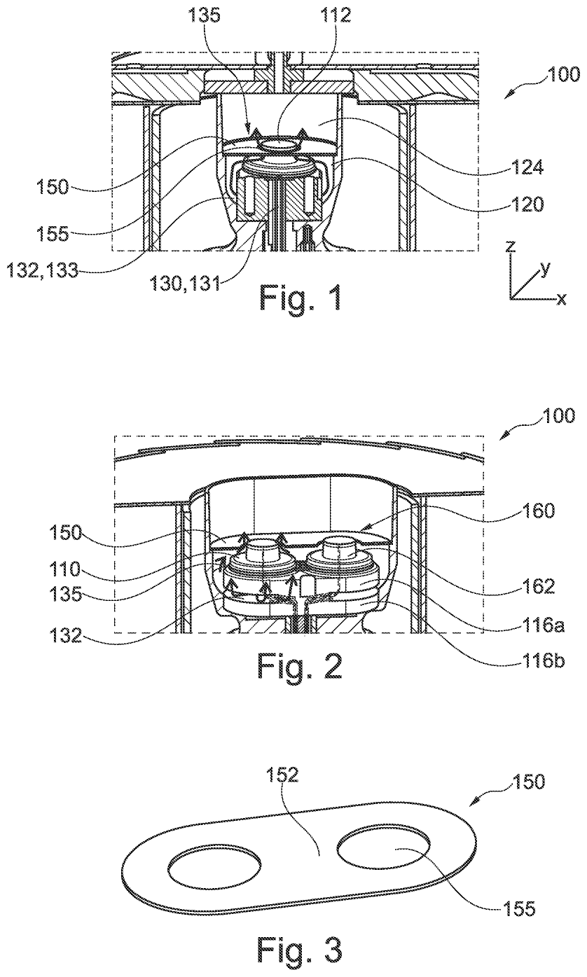

FIG. 1 shows a measuring device 100 for a thermal analysis according to an exemplary embodiment of the invention. The measuring device 100 comprises a sensor device 110 which is configured for capturing a thermal measurand with respect to a sample. The sensor device 110 has a lower base region 116, e.g. made of metal, and an upper sample storing region 112. The sample storing region 112 is arranged on the base region 116 and partially overlaps it (see FIG. 5). From this overlapping disk-shape, the sample storing region 112 extends perpendicularly (in direction z) in form of a truncated cone from a main surface (directions x, y) of the base region 116 (i.e., protrudes). Distally from the base region 116, the sample storing region 112 comprises a contact region, in particular a platform, 115 on which a sample crucible can be arranged, i.e., a sample reception is storable.

The measuring device further comprises an interior with a lower region, the sensor interior 120, and an upper region, the sample interior 124. In the sensor interior 120, the main part of the sensor device 110 is arranged, while in the sample interior 124, only the uppermost part of the sample storing region 112 (in particular the platform 114) is arranged, on which the sample reception is placed.

The measuring device 100 comprises a rinsing gas supply device 130 which is configured for providing a rinsing gas 135 into the sensor interior 120 and the sample interior 124. In this example, the rinsing gas supply device 113 comprises a gas supply conduit 131 (in particular comprising a capillary) which conducts the rinsing gas out of a reservoir through a heating region of the measuring device 100 and the base region 116 into the sensor interior 120 (also see the gas flow opening 132 and the gas flow transition 133).

The measuring device 100 according to the disclosure comprises a gas-conducting element 150 which is substantially formed as a lid with holes in this example. The gas-conducting element 150 is provided as a delimitation of the sensor interior 120 with respect to the sample interior 124. However, the gas-conducting element 150 comprises an opening 155 through which the upper part (in particular the platform 114) of the protruding sample storing region 112 extends, such that a slit between a side wall 111 of the protruding sample storing region 112 and the gas-conducting element 150 remains. The gas stream 135 from the gas supply device 130 is upwardly delimited only by the gas-conducting element 150 (here a sensor covering sheet metal). The gas-conducting element 150 is therefore configured such that the rinsing gas 135 is conducted from the sensor interior 120 into the sample interior 124 exclusively through the opening 155.

By this measure, a distinctly improved stream of the rinsing gas 135 in the region of the outer surfaces of the sensor device 110 and the sample receptions can be achieved. They are now uniformly and homogenously streamed around, such that also less rinsing gas has to be used.

FIG. 2 shows a measuring device 100 similar as above described, but with an additional reference sensor device 160, according to an exemplary embodiment of the invention. The reference sensor device 160 comprises a reference sample storing region 162 which protrudes from the base region 116. In this example, the sample storing region 112 and the reference sample storing region 162 share the same base region 116. The sample storing region 112 and the reference sample storing region 162 are structurally the same, preferably identical, and are arranged adjacent to each other.

In this example, the base region 116 comprises an upper element 116a and a lower element 116b, wherein a gas flow opening 132 is arranged between the upper element 116a and the lower element 116b. Therefore, in this example, the rinsing gas 130 streams out of the base region 116 in a ring-shaped manner into the sensor interior 120.

The gas-conducting element 150 comprises a further opening 155 through which the protruding reference sample storing region 162 extends. Also here remains a slit between a further side wall of the protruding reference sample storing region 162 and the gas-conducting element 150. The stream of the rinsing gas 135 now enters through the slit and the further slit from the sensor interior 120 into the sample interior 124, respectively in a rotationally symmetrical and homogeneous manner.

FIG. 3 shows a gas-conducting element 150 according to an exemplary embodiment of the invention. The gas-conducting element 150 is here formed as a planar metal plane 152 (sheet metal) and as a lid for the sensor interior 120. Respectively one opening 152 (in particular circular) is provided for the sample storing region 112 and the reference sample storing region 162. The gas-conducting element 150 may horizontally lie on a plane slightly below the sample- and/or the reference-platform 114. Ideally, the gas-conducting element 150 is removable or exchangeable in a destruction-free manner. The gas-conducting element 150 should consist of a heat-stable material, such as a metal (e.g. silver) or a ceramic (refractory ceramic) which is resistant against heating the oven.

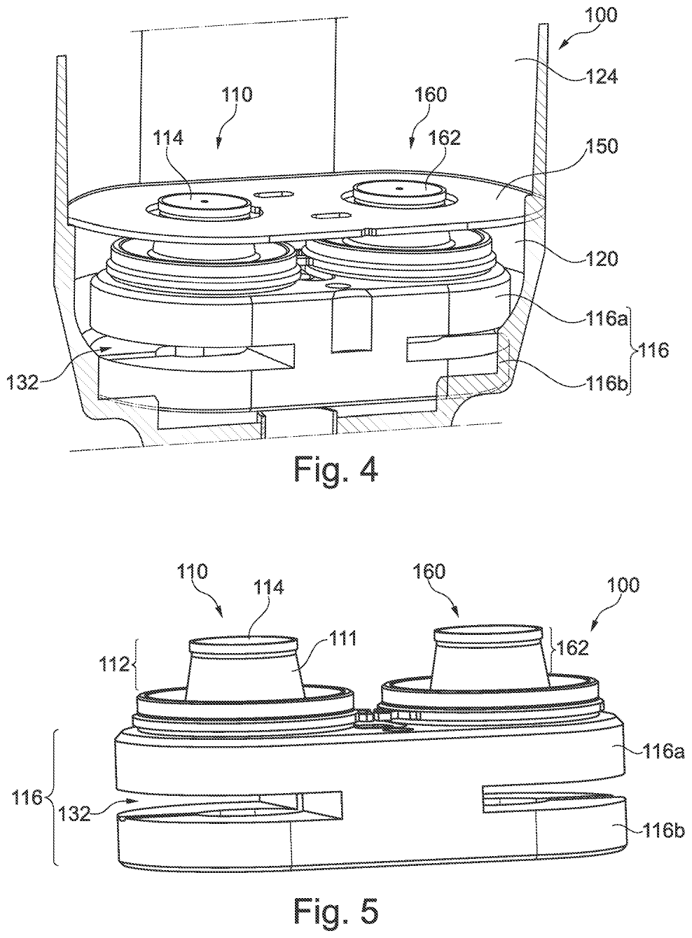

FIGS. 4 and 5 respectively show a sensor device 110 and a reference sensor device 160 according to exemplary embodiments of the invention.

FIG. 4: the elements which are already described above are clearly presented here again. The base region 116 comprises an upper part 116a and a lower part 116b, between which a gas flow opening 132 (discharge groove) is formed. Thermal element wires/sensor conduits (not shown) respectively extend through the base region 116 to the platforms 114 of the sample storing region 112 and the reference sample storing region 162.

In an exemplary embodiment, the sensor device 110 has a thin wall structure which contains the sample storing region 112, wherein the thin wall structure comprises a surrounding side wall 111 which delimits a hollow in its interior. Furthermore, the sensor device 110 has a contact structure 114 (platform) which is formed as a lid above this hollow, and on which the sample reception can be placed. A protrusion in the upper region of the side wall 111 enables stably arranging the contact structure 114. A lower region of the thin wall structure lies on the base region 116 as a thin bottom and overlaps the base region 116 for a stable attachment. In an exemplary embodiment, the thin wall structure is made of constantan, while the contact structure comprises cromel. The sample storing region 112 and the base region 116 may be pressed together via a tensile wire (not shown). The embodiments for the sample storing region 112 also apply for the reference sample storing region 162 which is structurally the same.

FIG. 5 shows the same elements as FIG. 4 in another perspective.

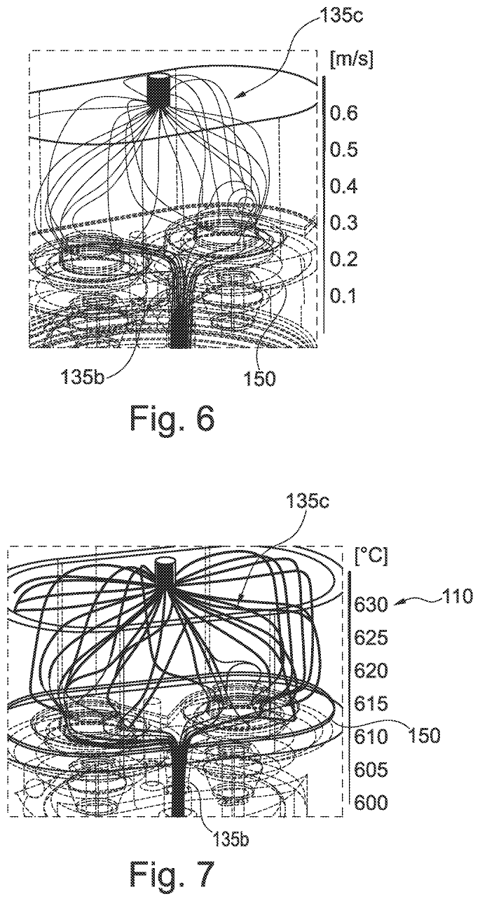

FIGS. 6 and 7 respectively show simulations of the streaming gas 135 through the gas-conducting element 150 according to an exemplary embodiment of the invention. While the reference sign 135c denotes the gas flow above the gas-conducting element 150 (in the sample interior 124), 135b relates to the gas flow below the gas-conducting element 150 in the sensor interior 120.

FIG. 6 shows the simulation results for a stationary stream calculation. The entering volume stream at the lower gas supply conduit 131 and/or the gas flow opening 132 is 50 ml/min. The gas stream or the rinsing gas has a constant temperature. The stream around the sample storing region 112 by using the gas-conducting element 150 obviously works efficiently. The entire pressure loss through the oven interior is 4.54 Pa. The maximum streaming velocity reaches 0.7 m/s.

FIG. 7 shows the simulation result with respect to the streamlines 135 of the rinsing gas with an associated temperature distribution during heating after 48 secs. Also here, a homogeneous streaming around the sample storing region 112 can be determined. Along the Y-axis, the gas temperature is shown in ºC.

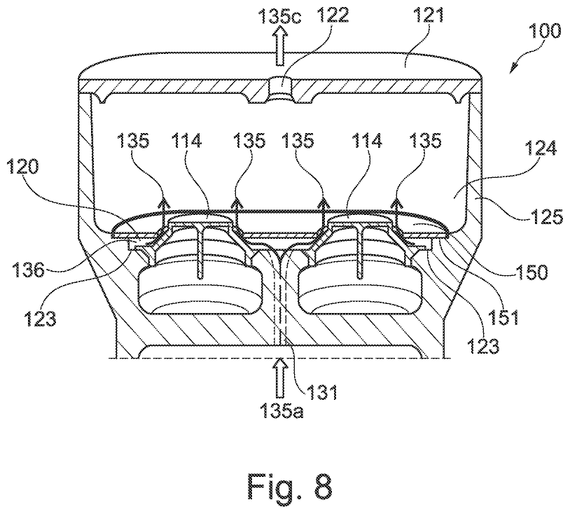

FIG. 8 shows a measuring device 100 according to exemplary embodiments of the invention. In this example, an oven covering 121 is shown which upwardly delimits the sample interior 124. The oven covering 121 comprises an oven outlet 122 through which the rinsing gas flow 135c can discharge from the oven interior. Furthermore, at the oven bottom 123, a storage place 151 (bearing edge) is provided, on which the gas-conducting element 150 can be placed. Thereby, a simple cleaning/exchange of the gas-conducting element 150 is enabled. By the storage place 151, it is ensured, that the gas-conducting element 150 does not close the opening, and that between the oven bottom 123 and the gas-conducting element 150, a streaming channel 136 is formed. For optimizing the stream guidance, a spiral channel guidance in the direction of the openings can be implemented in the streaming channel, to achieve an improved uniformly formed rinsing gas stream around the outer surfaces of the sensor device 110. The opening for introducing the rinsing gas is preferably located along the symmetry plane of the oven (for example along a line between both sensors and/or sensor parts) and below the gas-conducting element 150.

It is noted that the term “comprising” does not exclude other elements or steps, and the use of the article “a” does not exclude a plurality. Also elements which are described in connection with different embodiments may be combined. It is further to be noted that reference signs in the claims shall not be construed as limiting the scope of the claims.

### REFERENCE SIGNS

100 measuring device, calorimeter,
106 reference sample reception
110 sensor device
111 thin side wall
112 sample storing region
114 contact structure, platform
116 base region
116a base region upper element
116b base region lower element
120 sensor interior
121 oven covering
122 oven outlet
123 oven bottom
124 sample interior
125 oven wall
130 gas supply device
131 gas supply conduit
132 gas flow opening
133 gas flow transition
135 gas flow
135a gas flow supply
135b gas flow in the sensor interior
135c gas flow out of the sample interior
136 streaming channel
150 gas-conducting element, covering element
151 storage place
152 metal surface
155 opening
160 reference sensor device
162 reference sample storing region

1. A measuring device, comprising:
a sensor device which is configured for capturing a measurand with respect to a sample and which comprises:
a base region, and
a sample storing region which protrudes from a main surface of the base region and which is configured for storing a sample reception;
a sensor interior in which the sensor device is at least partially arranged;
a rinsing gas supply device which is configured for providing a rinsing gas in the sensor interior; and
a gas-conducting element which covers the sensor interior and which comprises:
at least one opening through which the protruding sample storing region at least partially extends, such that a slit between a side wall of the protruding sample storing region and the gas-conducting element remains.

2. The measuring device according to claim 1,
wherein the gas-conducting element is configured such that the rinsing gas is conducted through the at least one opening out of the sensor interior.

3. The measuring device according to claim 1,
wherein the gas-conducting element is formed substantially planar.

4. The measuring device according to claim 1,
wherein the opening and the slit are comparable with respect to their area geometry.

5. The measuring device according to claim 1,
wherein the distance between the side wall of the sample storing region and the gas-conducting element in the opening is in a range from 0.25 mm to 5 mm; or wherein the gas-conducting element comprises a thickness in a range from 0.05 mm to 1 mm.

6. The measuring device according to claim 1, further comprising:
a sample interior which is configured for containing at least one sample reception, and
wherein the gas-conducting element delimits the sensor interior from the sample interior.

7. The measuring device according to claim 1,
wherein the gas-conducting element comprises a heat resistant material.

8. The measuring device according to claim 1,
wherein the gas-conducting element is removable or exchangeable in a destruction-free manner.

9. The measuring device according to claim 1, wherein the sensor device further comprises:
a thin wall structure which contains the sample storing region, wherein the side wall delimits a hollow; and
a contact structure for contacting the sample reception;
wherein the thin wall structure extends on the same height as the contact structure or below through the opening of the gas-conducting element.

10. The measuring device according to claim 1,
wherein a width of the base region is larger than a width of the sample storing region.

11. The measuring device according to claim 1, wherein the base region further comprises:
a gas flow opening which is configured for conducting the rinsing gas at least partially through the base region into the sensor interior.

12. The measuring device according to claim 1, wherein the sensor device further comprises:
a reference sensor device which comprises a protruding reference sample storing region and is arranged adjacent to the sample storing region.

13. The measuring device according to claim 12,
wherein the gas-conducting element comprises at least one further opening through which the protruding reference sample storing region extends, such that a further slit between a further side wall of the protruding reference sample storing region and the gas-conducting element remains.

14. The measuring device according to claim 1,
wherein the measuring device comprises a differential scanning calorimeter or a differential thermal analysis measuring device.

15. The measuring device according to claim 1, further comprising at least one of:
a heating device, a cooling device, a thermal resistance, an electrothermal converter a rinsing gas supply conduit which extends at least partially through the measuring device.

16. A method for rinsing a measuring device the method comprising:
providing a rinsing gas in a sensor interior in which a sensor device is at least partially arranged, wherein the sensor device comprises a base region from which a sample storing region protrudes; and
covering the sensor interior by a gas-conducting element, such that the protruding sample storing region extends at least partially through an opening of the gas-conducting element, so that a slit between a side wall of the protruding sample storing region and the gas-conducting element remains.

17. The method according to claim 16,
wherein a flow of the rinsing gas exits from the slit in a rotationally symmetrical manner.

18. The method according to claim 16, further comprising:
providing a sample reception in a sample interior which is separated from the sensor interior by the gas-conducting element.

19. The method according to claim 16,
wherein the flow of the rinsing gas through the sensor interior tempers the rinsing gas.

20. Use of a lid with at least one opening for covering a sensor interior of a measuring device with respect to a sample interior, such that a substantially homogenous rinsing gas flow through the sensor interior into the sample interior is provided.
